(19) United States
(12) Patent Application Publication
(10) Pub. No.: US 2004/0028560 A1
(43) Pub. Date: Feb. 12, 2004

(54) Substance detection method and substance detection apparatus

(76) Inventors: Katsumi Nagumo, Yokohama (JP); Mitsuhiro Noda, Fujisawa (JP); Masayuki Takizawa, Yokohama (JP); Shigenori Morishima, Fujisawa (JP); Tatsuo Nojiri, Takasaki (JP); Kosho Aikawa, Yokohama (JP); Naoya Sasaki, Tomobe (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/426,718

(22) Filed: May 1, 2003

(30) Foreign Application Priority Data
Aug. 7, 2002 (JP) 2002-229406

(51) Int. Cl. G01N 31/00

(52) U.S. Cl. 422/83

(57) ABSTRACT

A substance detection method includes the steps of: heating a sample adhered to a substance with a temperature at which the substance is readily vaporized to vapor the substance; sucking air and feeding the sucked air in a direction different from a direction along which the substance is vaporized; negatively ionizing the vapor sucked with the air; and detecting the substance adhered to the sample by analyzing the negative ion.

### BACKGROUND OF THE INVENTION

The present invention relates to a method of detecting substances and also to an apparatus of realizing this substance detection method. Conventionally, as related art for desirably realizing methods and apparatus capable of detecting a substance such as an explosive, for example, U.S. Pat. No. 5,071,771 has disclosed a method for introducing an air into an analysis data processing unit with the air sucked therein, in which the air has been blown through a sample adhered with a substance.

### SUMMARY OF THE INVENTION

However, in the conventional method for blowing the sucked air through the sample, there may exist a case where detection sensitivity is frequently lowered due to clogging of a filter or other causes, since a large amount of fibers, trash or the like are brought with the sample. In particular, there is problem as to the detection sensitivity in the case that a vapor pressure of substance is low and also the substance is trace amount.

An object of the present invention is therefore to provide a substance detection method and a substance detection apparatus capable of detecting the substance in high sensitivity even in such a case that vapor pressure of the substance is low and the substance is trace amount.

To solve the above-described problem, an aspect of the present invention is that a substance detection apparatus comprises: a sample introduction unit that heats the sample adhered to the substance with a temperature at which the substance is readily vaporized to vapor the substance; an ionizing unit that ionizes the vapor fed from the sample introduction unit; a mass analyzing unit that maintains an under decompression condition to analyze an ion ionized by the ionizing unit; a control unit that controls the sample introduction unit, the ionizing unit and the first analysis data processing unit; and an analysis data processing unit that processes data analyzed by the first analysis data processing unit to display the processed data on a screen.

In accordance with the present invention, the above-explained sample introduction unit owns a feature in order to enhance a detection sensitivity. The sample introduction unit is comprised of: a sample holder tray for mounting thereon the sample adhered on the substance; a heating unit for heating the sample mounted on the sample holder tray to vapor the substance adhered with the sample; and an air introduction tube for sucking air, feeding the sucked air into a direction different from a direction along which the substance is vaporized, and for introducing the vapor to the ionizing unit. Also, in order to remove dust contained in the air, a filter is provided with the air introduction tube. Since this structure is employed, the detection sensitivity can be furthermore enhanced.

Also, in accordance with the present invention, the substance detection apparatus is featured by that a switch is provided with the sample introduction unit to notify such a fact that the sample holder tray has been inserted into the heating unit to the control unit. The analysis data processing unit senses such a fact that the sample holder tray has been inserted into the heating unit, so that the analysis data processing unit can recognize that data received after this sensing operation corresponds to effective data required for analyzing operations. Also, the operation of the analysis data processing unit is previously set in such a manner that when the analysis data processing unit detects such a fact that the switch has been depressed, this analysis data processing unit acquires such data before/after this switch depression detection as effective data, while this detection timing is used as a trigger. As a result, since there is no failure in the acquisition of the effective data, the detection sensitivities can be enhanced.

Other objects, features and advantages of the invention will become apparent from the following description of the embodiments of the invention taken in conjunction with the accompanying drawings.

### BRIEF DESCRIPTION OF THE DRAWINGS

FIG. 1 is a schematic block diagram for indicating an entire arrangement of a substance detection apparatus to which the present invention has been applied.

FIG. 2 is a view for showing a construction of a sample introduction unit, as viewed from an upper direction thereof.

FIG. 3 is a view for indicating the construction of the sample introduction unit, as viewed from a lateral direction thereof.

FIG. 4 is a view for representing the construction of the sample instruction unit of the substance detection apparatus.

FIG. 5 is a construction of a switch.

FIG. 6 is a diagram for schematically showing an arrangement of a control unit.

FIG. 7 is a diagram for schematically indicating a structure of a register.

FIG. 8 is a diagram for schematically indicating an arrangement of an analysis data processing unit.

FIG. 9 is a diagram for schematically showing a structure of a memory.

FIG. 10 is a flow chart for describing process operations of a processor.

FIG. 11 graphically shows an example of analysis results displayed on a display screen.

FIG. 12 is a structural diagram for indicating another embodiment of the sample introduction unit.

FIG. 13 is a structural diagram for indicating another embodiment of a sample holder tray.

FIG. 14 is a structural diagram for showing another embodiment of the sample holder tray.

FIG. 15 is a structural diagram for representing another embodiment of the sample holder tray.

FIG. 16 is a structural diagram for indicating another embodiment of the sample holder tray.

FIG. 17 is a structural diagram for showing another embodiment of the sample holder tray.

FIG. 18 is a structural diagram for representing another embodiment of the sample holder tray.

### DESCRIPTION OF THE EMBODIMENTS

Referring now to drawings, embodiments of the present invention will be described in detail.

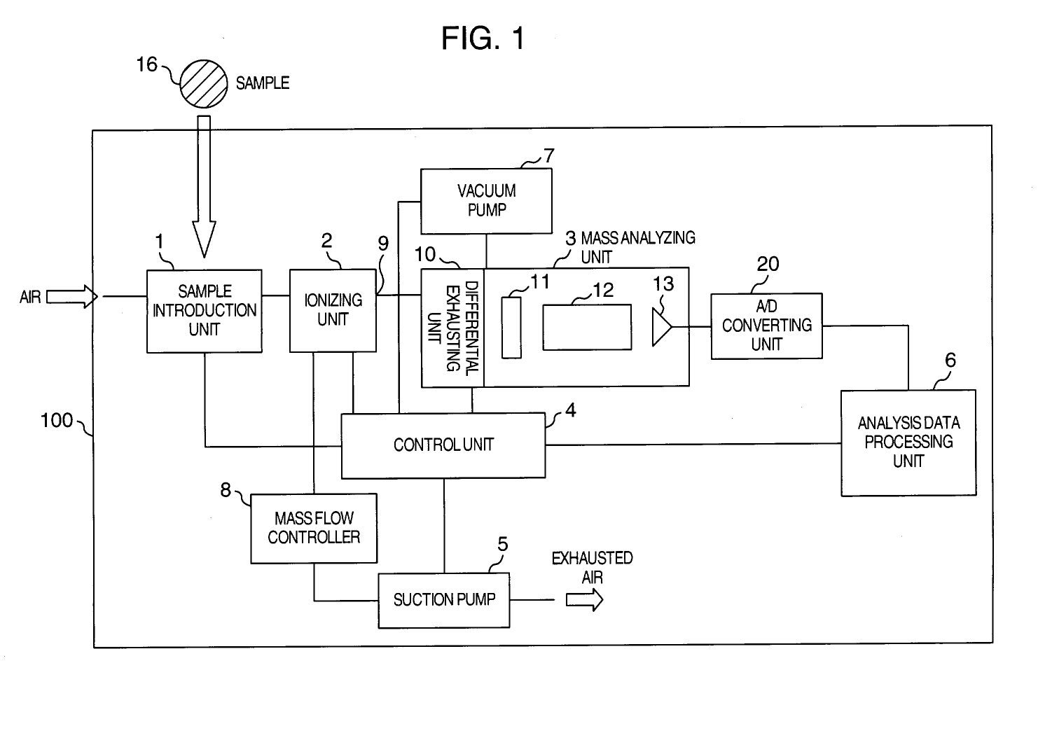

FIG. 1 is a block diagram for indicating an arrangement of a substance detection apparatus 100 to which the present invention has been applied. The substance detection apparatus 100 is constituted by a sample introduction unit 1, an ionizing unit 2, a mass analyzing unit 3, a control unit 4, a suction pump 5, an analysis data processing unit 6, a vacuum pump 7, and a mass flow controller 8.

The sample introduction unit 1 owns a heating mechanism for effectively heating an introduced sample. A sample 16 adhered to a substance such as explosive is heated by the heating mechanism, vaporizing the substance. The sample 16 is, for example, a waist, paper, and fluorocarbon polymer sheets. The substance such as an explosive is, for instance, RDX (Research and Development Explosive), TNT (Trinitrotoluene), and NG (Nitroglycerin). This vapor is conducted to the ionizing unit 2 by an air flow which is sucked by the suction pump 5. The ionizing unit 2 ionizes the vapor in response to substance components of an object to produce negative ions by way of an applied minus high voltage (about −2 kV to −5 kV). The reason why the minus high voltage is applied is given as follows: The substance such as the explosive own such nature that the substance is easily ionized to produce the negative ions. The negative-ionized component is conducted to the mass analyzing unit 3 by an electric field applied between the ionizing unit 2 and the mass analyzing unit 3. The mass analyzing unit 3 is constituted with a differential exhausting unit 10, an electrostatic lens system 11, a quadruple-pole mass analyzing meter 12, and a secondary electron multiplier 13, which are decompressed by the vacuum pump 7. After the negative ions are transported via the differential exhausting unit 10, the negative ions are converged by the electrostatic lens system 11, and then, are fed to the quadruple-pole mass analyzing meter 12. The quadruple-pole mass analyzing meter 12 analyzes the negative ions. The analyzed negative ions are converted into electrons by the secondary electron multiplier 13. A resulting current signal is amplified by an amplifier (not shown), and thereafter, the amplified current signal is sent to an A/D (analog-to-digital) converting unit 20. The A/D converting unit 20 sends the converted current data to the analysis data processing unit 6. The analysis data processing unit 6 measures a relationship (referred to as a “mass spectrum”) between mass number (m) of ions/electric charges (z) and an ion intensity, and a temporal change (referred to as a “mass chromatogram”) in the ion intensity of a certain m/z, and then, displays the measurement results on a screen. An expression “m/z” indicates a mass-to-ratio (ratio of mass to electric charge), namely, represents such a value obtained by dividing mass (m) of ions by an electric charge number (z). Also, the mass flow controller 8 variably controls an amount of air sucked by the suction pump 5 between zero and 5 L (liters)/min (minute). The suction pump 5 exhausts air outside the apparatus, which has been acquired via the mass flow controller 8. The vacuum pump 7 also owns a function capable of maintain an inner portion of a chamber in which the quadruple-pole mass analyzing meter 12 is entered under high vacuum condition. The control unit 4 controls the entire unit of the substance detection apparatus 100, and executes various control operations, e.g., ON/OFF controls of power supplies of the respective units, temperature setting controls of the sample introduction unit 1 and the ionizing unit 2, and pressure setting control of the mass analyzing unit 3. In this embodiment, the control unit 4 executes temperature-keeping-controls as to both the ionizing unit 2 and a vapor introduction path between the sample introduction unit 1 and the ionizing unit 2 at temperatures in the range of approximately 150 to 250° C. As a result, it is possible to avoid that the vapor adheres to an inner wall of the vapor instruction path and an inner wall of the ionizing unit 2.

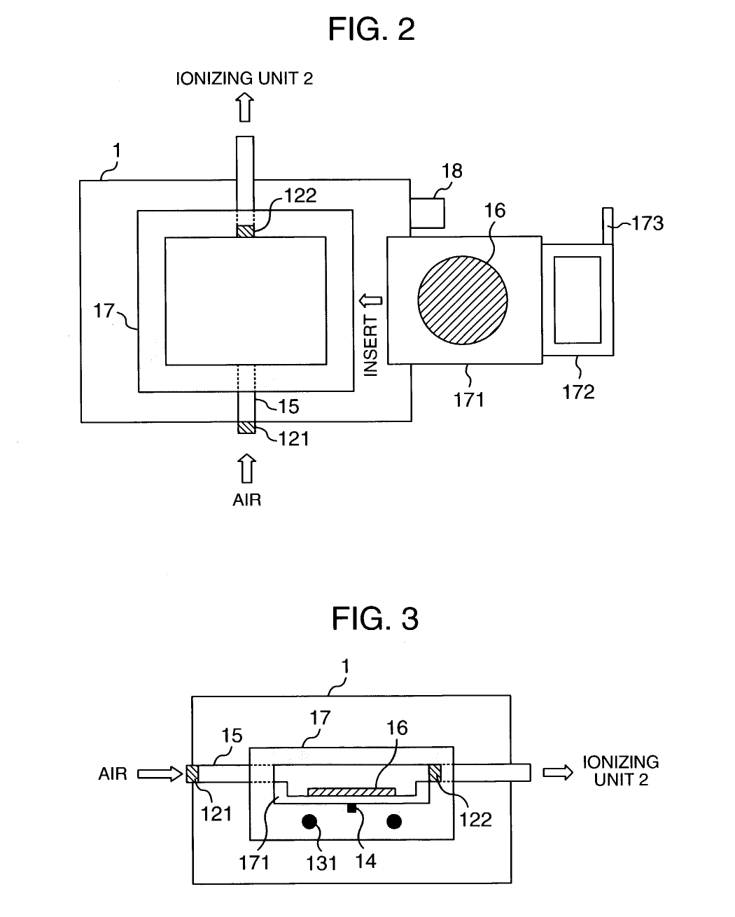

FIG. 2 is a view for showing a construction of the sample introduction unit 1, as viewed from an upper direction thereof. The sample introduction unit 1 is constituted with a sample holder tray 171, a heating unit 17, an air introduction tube 15, and the like. The sample holder tray 171 mounts thereon the sample 16. The heating unit 17 heats the sample 16 so as to vapor the substance adhered on this sample 16. The air introduction tube 15 sucks the air. Furthermore, this embodiment is featured by that a switch 18 is employed in the sample introduction unit 1 in order to notify such a fact that the sample holder tray 171 has been inserted into the heating unit 17 to the control unit 4. Since the internal portion of the sample introduction unit 1 is set under heating condition, such data which is not required for analyzing operations is also sent to the analysis data processing unit 6. Since the analysis data processing unit 6 senses such a fact that the sample holder tray 171 has been inserted into the heating unit 17, this analysis data processing unit 6 can recognize that data received after the insertion sensing operation corresponds to effective data which is required for the analyzing operation. Also, a handle 172 is provided on the sample holder tray 171 in order to easily insert/draw this sample holder tray 171. Also, a switch depressing portion 173 is provided on the handle 172 so as to depress the switch 18. It should be noted that the handle 172 may be constituted by employing such a material through which heat can hardly be conducted. A dust removing filter 121 is provided at an air intake port of the air introduction tube 15 in order to remove dust/dirt contained in air to be sucked. Furthermore, a trash/fiber removing filter 122 is provided on the air introduction tube 15 so as to remove trash, fibers, and the like, which have adhered to the sample 16.

In order to explain a construction of the heating unit 17, FIG. 3 shows a view of such a construction of the sample introduction unit 1, as viewed from a lateral direction thereof (namely, on the side of inserting sample holder tray 171). It should also be noted that FIG. 3 represents such a condition that the sample holder tray 171 has been inserted into the heating unit 17. As explained above, the sample 16 mounted on the sample holder tray 171 is heated by a heating mechanism of the heating unit 17. The heating mechanism of the heating unit 17 is realized by both a heater (cartridge heater, sheath heater, ceramics heater etc.), and a thermocouple 14. Both the heater 131 and the thermocouple 14 are controlled by the control unit 4. A temperature of a heating space may be set to an arbitrary temperature under control of the control unit 4. In this embodiment, the temperature of the heating space of the sample 16 is controlled to be maintained at temperatures of on the order of 150° C. to 250° C. by both the control unit 4 and the above-described heating mechanism. In other words, this temperature control is performed in order that substances adhered to the sample 16 are heated at an easily vaporizable temperature. In this case, dust contained in air is removed by a dust removing filter 121, and then, the resulting air is sucked into the air introduction tube 15. The air sucked into the air introduction tube 15 is fed to the space where the sample 16 is positioned in such a manner that this fed air may cover the upper surface of the sample 16. Vapor produced by heating the sample 16 was fed to the ionizing unit 2 by this air. As previously explained, trash, fibers, and the like, which are not required for the analyzing operation, are removed by a trash/fiber removing filter 122. It should be understood that since it is so conceivable that the trash/fiber removing filter 122 may be clogged by the above-described trash/fibers, this filter 122 preferably owns an easily replaceable construction, i.e., may be readily replaced by a new one on the side of a user who uses this apparatus. For instance, since a space for mounting the filter 122 is provided on the side of the ionizing unit 2 of the sample holder tray 171, this filter 122 may be readily replaced by a new one when the sample holder tray 171 is drawn.

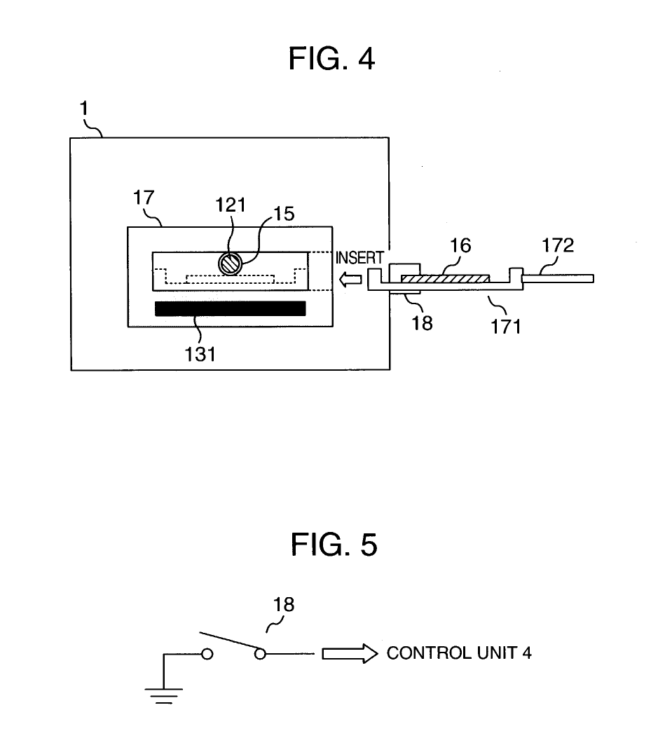

FIG. 4 is a view for indicating a construction of the sample introduction unit 1, as viewed from a front side thereof (namely, on the side where air is sucked to sample introduction tube 15). FIG. 4 shows such a condition that the sample holder tray 171 is inserted into the heating unit 17 from a lateral direction. The sample holder tray 171 may be formed in such a construction that this sample holder tray 171 may be completely separated from the heating unit 17, or may be used under half-insertion condition. In addition, the sample holder tray 171 may also be a construction such that the tray 171 is inserted into the heating unit 17 from the front side, due to enhancement of work.

FIG. 5 indicates a construction of the switch 18 of the sample introduction unit 1. When the sample holder tray 171 is inserted into the heating unit 17, the switch 18 is depressed by the switch depressing portion 173, and a signal for indicating that this switch 18 has been depressed is transmitted to the control unit 4.

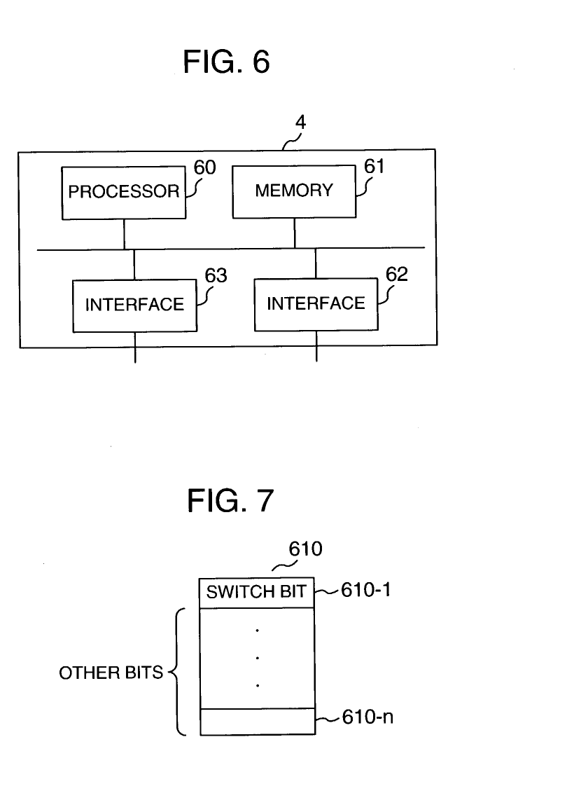

FIG. 6 is a diagram for representing an arrangement of the control unit 4. The control unit 4 is arranged by a processor 80, a memory 61, interfaces 62, 63, and the like. A program has been stored in the memory 61, which is executed to control the sample introduction unit 1, the ionizing unit 2, the mass analyzing unit 3, and the like. Also, a register 610 (FIG. 7) has been stored in this memory 61. The register 610 is constituted by a switch bit storage area 610-1, and a plurality of storage areas 610-1 to 610-n. The switch bit storage area 610-1 stores a switch bit used in this embodiment, and the plural storage areas 610-1 to 610-n store other bits. In this embodiment, when the processor 60 detects the above-described signal, the processor 60 writes “1” into the switch bit storage area 610-1. Based upon this switch bit, such a fact that the switch 18 is depressed can be detected. The interface 62 corresponds to such an interface to this control unit 4 with respect to the sample introduction unit 1, the ionizing unit 2, the mass analyzing unit 3, and the like. The processor 60 controls the sample introduction unit 1, the ionizing unit 2, the mass analyzing unit 3, and the like via the interface 62. The interface 63 corresponds to such an interface which interfaces this control unit 4 with respect to the analysis data processing unit 6.

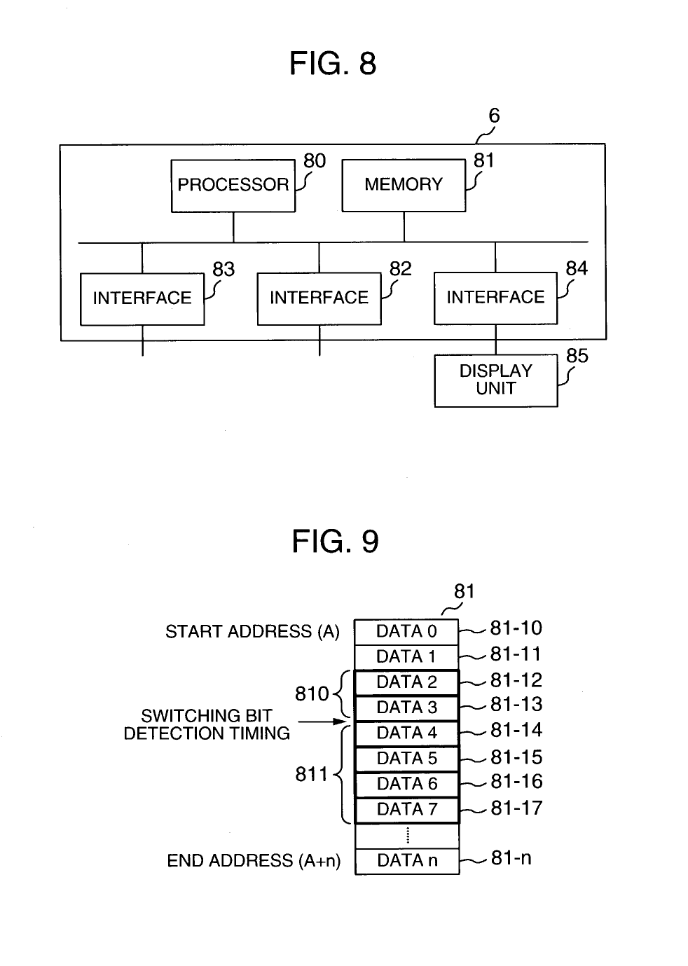

FIG. 8 is a diagram for indicating an arrangement of the analysis data processing unit 6. The analysis data processing unit 6 is constituted by a processor 80, a memory 81, interfaces 82 to 84, a display unit 85, and the like. Data for analysis purposes has been stored in the memory 81, which has been received via the sample introduction unit 1, the ionizing unit 2, the mass analyzing unit 3, and the A/D converting unit 20. Also, a process program has been stored in the memory 81, and this program is used to execute a data analyzing operation for data to be analyzed. The interface 82 corresponds to such an interface to this analysis data processing unit 6 with respect to the A/D converting unit 20. The data for analysis purposes is received by the interface 82. The interface 83 corresponds to such an interface to this analysis data processing unit 6 with respect to the control unit 4. In this embodiment, the processor 80 reads out the content of the register 610 contained in the memory 61 via the interface 83 in a periodic manner. The interface 84 corresponds to such an interface to this analysis data processing unit 6 with the display unit 85. The display unit 85 owns a function capable of displaying an analysis result on the display screen. When the processor 80 detects a change in the switch bit 610-1, this processor 80 may recognize reception data after the detection of the switch bit change as effective data. Also, in this embodiment, the processor 80 may also recognize the reception data received before the switch 18 is depressed as the effective data. This reason of the data recognition is given as follows: That is, there are some possibilities that acquisitions of such data may fail which has been received within a time period defined after the switch 18 has been depressed until the analysis data processing unit 6 detects this switch depression. Such a case may sufficiently surely occur in which the data received during the above-described time period becomes effective. More specifically, when the switch 18 owns a mechanical construction, there are higher possibilities that data acquisition failure may occur. In this embodiment, the data acquisition has been previously set in such a manner that while a time instant when a switch bit is detected is used as a trigger, data received before/after this time instant is acquired as the effective data.

FIG. 9 is a diagram for indicating a structure of the memory 81. Data storage areas of this memory 81 are managed based upon addresses. Data for analysis purposes are sequentially written into these data storage areas from a starting address (A) by the processor 80. When the data writing operation executed up to an end address (A+n) is accomplished, the data writing operation is returned to the starting address (A) at which data is overwritten. In FIG. 9, reference numeral 810 indicates effective data before the switch bit 610-1 is detected by the processor 80. Reference numeral 811 shows effective data after the switch bit 610-1 is detected by the processor 80.

In this embodiment, the analysis data processing unit 6 stores the data for analysis purposes which is received via the interface 83 into the memory 81, and also, reads the register 610 contained in the control unit 4 via the interface 84 in a periodic manner irrespective of such a fact as to whether or not the soft detecting switch 18 is depressed. When the change in the switch bit 610-1 is detected, the analysis data processing unit 6 reads both data corresponding to a preset forward-effective count number and data corresponding to a preset backward-effective count number from the memory 81 so as to analyze ion intensity and the like.

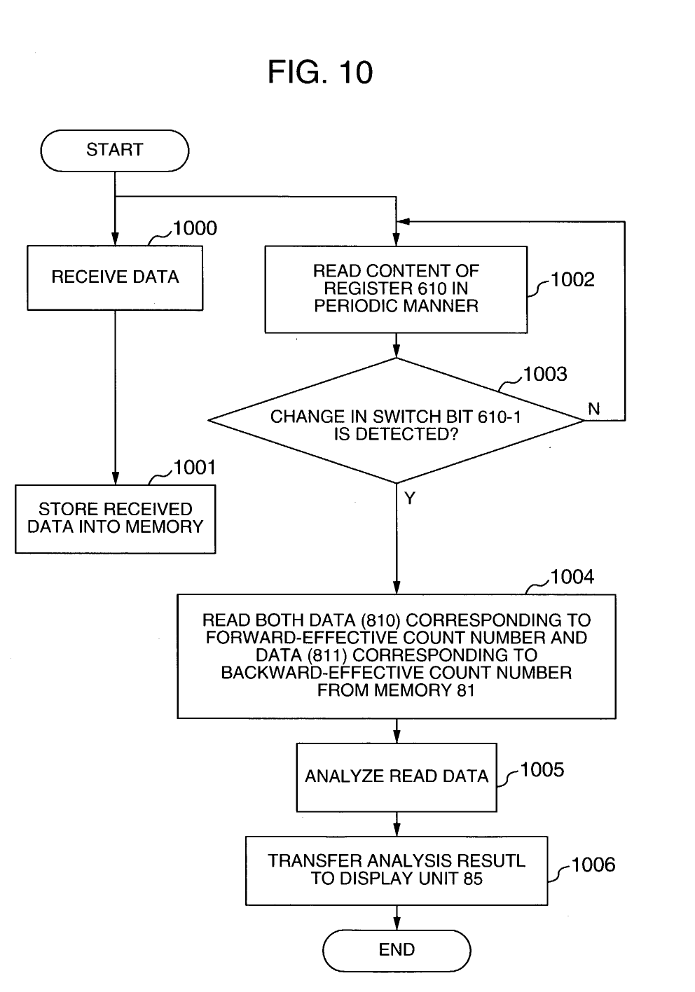

FIG. 10 is a flow chart for describing process operation executed by the processor 80 provided in the analysis data processing unit 6. The processor 80 receives data for analysis purposes via the sample introduction unit 1, the ionizing unit 2, the mass analyzing unit 3, the A/D converting unit 20, and the interface 82 (step 1000). The processor 80 writes this received data into the memory 81 (step 1001, FIG. 9). Also, the memory 80 reads the content of the register 610 via the interface 83 and the interface 63 in the periodic manner (step 1002), and judges as to whether or not there is a change in the switch bit 610-1 (step 1003). If the processor 80 does not detect such a change in the switch bit 610-1, then the process operation is returned to the step 1002. When the processor 80 detects such a change (e.g., “0” into “1”) of the switch bit while this processor 80 writes the received data into the memory 81, the processor 80 reads both data (81-12, 81-13) corresponding to the forward-effective count number (for example, −2 counts) and also data (81-14 to 81-17) corresponding to the backward-effective count number (for example, +4 counts), which have been previously set while this time instant (switch bit detection timing) is defined as a reference (defined as count “0”) (step 1004). The processor 80 analyzes the read data so as to acquire ion intensity (step 1005). The processor 80 transfers this analysis result via the display interface 84 to a display unit 85 (step 1006). When the display unit 85 receives the analysis result, this display unit 85 executes a predetermined process operation with respect to this analysis result, and then displays the processed analysis result on the screen of the display unit 85.

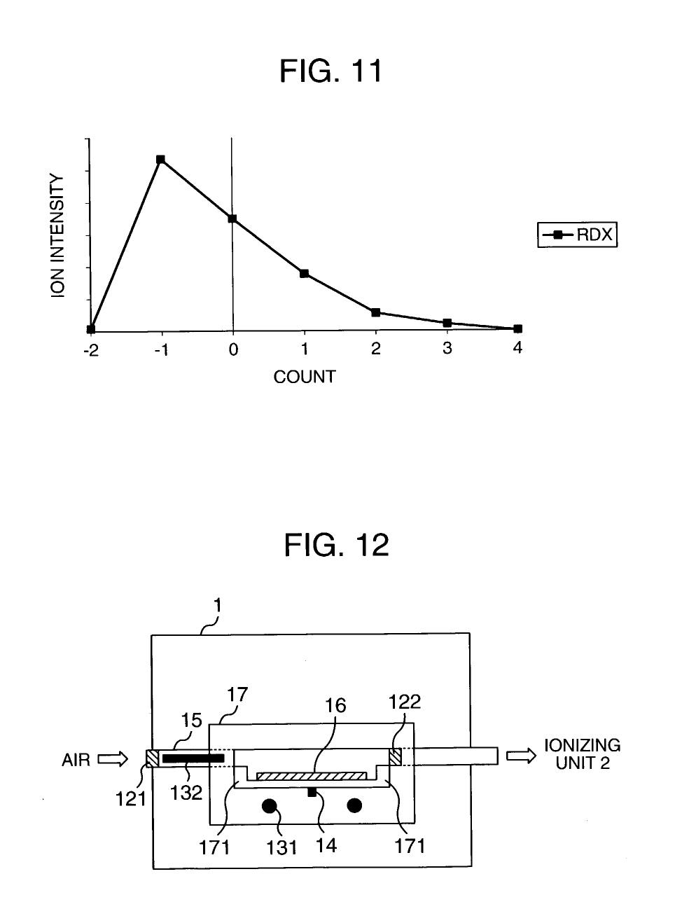

FIG. 11 indicates an example (for example, RDX) of an analysis result displayed on the display unit 85. In this drawing, an abscissa indicates the above-defined count, and an ordinate shows ion intensity. In accordance with this analysis result, it can be understood that a peak of the ion intensity appears at −1 count. As a consequence, since the switch 18 is employed, even in such a case that the peak of the ion intensity appears before the switch 18 is depressed, the failure of the data acquisition at this time instant can be avoided, and therefore, the detection sensitivity can be improved. It should be noted that even when the peak of the ion intensity appears after the switch bit is depressed, the data at this time can be detected without data acquisition failure, which could be obvious from the above-explained embodiment.

FIG. 12 is a structural diagram for indicating another embodiment as to the sample introduction unit 1 employed in the substance detection apparatus (namely, as viewed from lateral direction thereof). It should be noted that the same reference numerals shown in FIG. 2 will be employed as those for denoting the same, or similar structural elements indicated in FIG. 12. In this embodiment, a heat-purpose heater (heating mechanism) 132 is provided within the air introduction tube 15. After air sucked into the air introduction tube 15 has been heated by the heat-purpose heater 132 at a temperature on the order of 150° C. to 250° C., the heated air is fed to the heating unit 17. At a consequence, an efficiency of vaporizing substances adhered to the sample 16 can be increased, and therefore, a detection sensitivity can be improved.

Also, in the above-described embodiment, such an example has been described in which the analysis data processing unit 6 displays the mass spectrum and the mass chromatogram on the display screen. Alternatively, a further simple display system may be employed. For example, such a fact as to whether or not a substance to be examined has been detected may be merely displayed on the display screen.

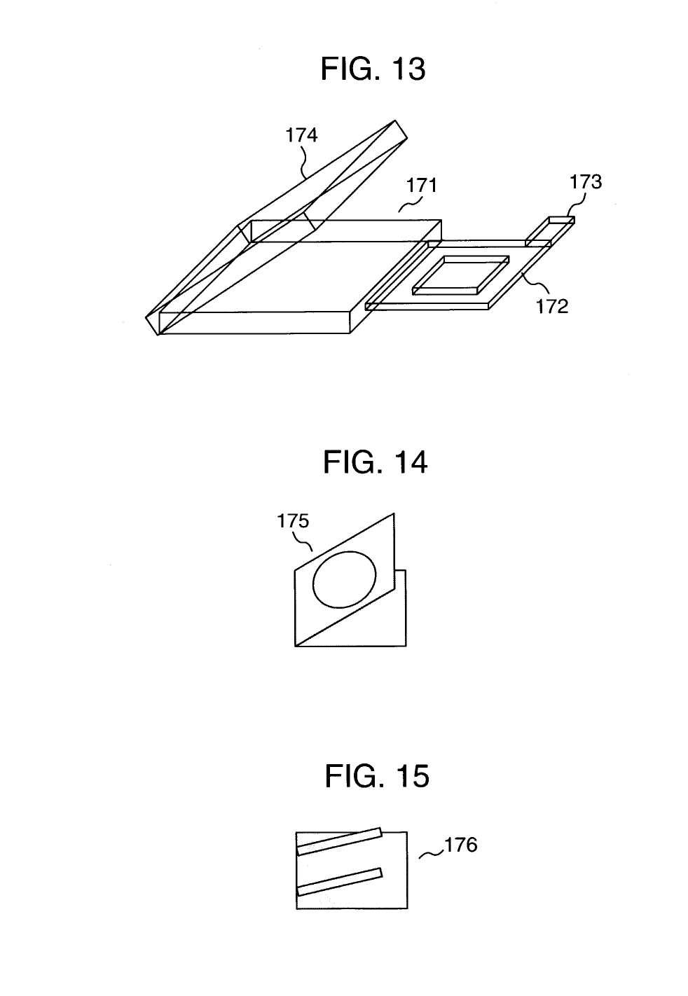

Also, the above-explained embodiment has described such a case that an upper lid is not provided with the sample holder tray 171. Alternatively, as shown in FIG. 13, an upper lid 174 may be provided. The provision of this upper lid 174 may become effective in the case that the sample 16 is a cloth, or paper, which is required to be fixed. Also, since the sample 16 is depressed by the upper lid 174 so that this sample 16 is depressed against the bottom portion, such an effect of contact heat transfers obtained from the bottom portion may be expected. It should also be noted that since the flow of the vaporized substance is impeded by employing such a structure that the sample 16 is simply covered, the detection sensitivity is lowered. As a consequence, structural examples capable of improving a heating efficiency and a detecting efficiency are illustrated in FIG. 14 to FIG. 18. For the sake of simple explanations, only the upper lid 174 and the bottom portion of the sample holder tray 171 are illustrated.

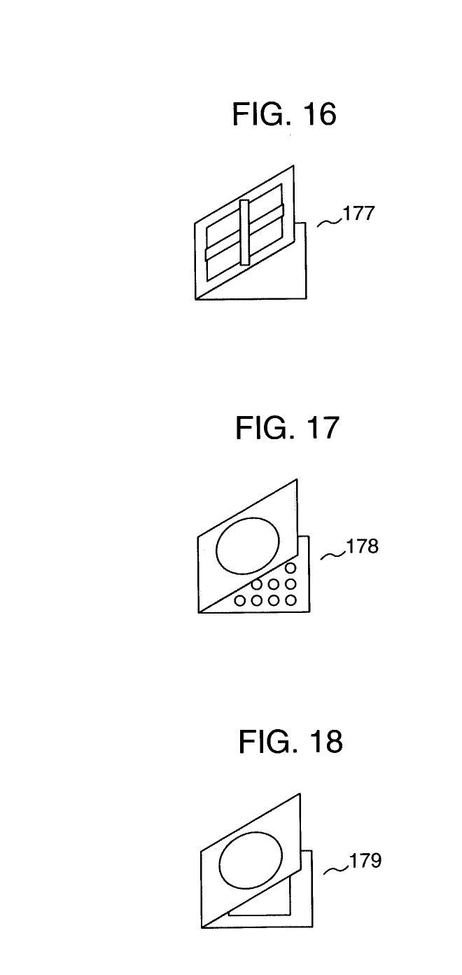

FIG. 14 indicates a structure 175 in which a round hole is formed in the upper lid 174, and an outer circumference of the sample 16 is depressed. Since the sample 16 can be depressed without impeding flows of vaporized substances by employing this structure, a heating efficiency can be increased. In the case that the sample 16 is such a thin sample as a cloth and paper, both the sample holder tray 171 and the upper lid 174 are made thinner, a better heat transfer characteristic can be achieved, a heating efficiency can be increased, and therefore, a detection sensitivity can be furthermore improved. If a mountaining area of the heating unit 17 for the sample holder tray 171 is made smaller, then a further improvement in the detection sensitivity may be expected. FIG. 15 shows another structure 176 in which a rod 175 is employed instead of the upper lid 174, and the sample 16 is depressed by this rod 175. Even when this structure 176 is employed, a heating efficiency can be improved. FIG. 16 indicates another structure 177 in which a hole having a rectangular shape is formed in the upper lid 174 and a depression having a cross shape is provided at an upper portion of this rectangular hole. Since this structure 177 is employed, there is such a merit that the shape of the sample 16 need not be specified. FIG. 17 represents another structure 178 in which a plurality of small holes are formed in a bottom portion in addition to the structure of FIG. 14. Since this structure 178 is employed, dust, fibers, and the like supplied from the sample 16 can be removed, and also, a maintenance efficiency can be increased. FIG. 18 shows another structure 179 in which a large hole having a rectangular shape is formed in the structure 175 of FIG. 14. Since this structure 179 is employed, a heat transfer efficiency can be furthermore increased in such a case that the sample 16 may be directly contacted to the heating unit 17.

Also, the above-described embodiment has indicated such an example that the sample holder tray 171 is provided with the sample introduction unit 1. Alternatively, such a structure may be employed. That is, while this sample holder tray 171 is not provided, an effect of a contact heat transfer from the heating unit 17 may be expected by, for instance, merely casting the sample 17 into the sample introduction unit 1. Since this alternative structure is employed, a heating operation may be carried out in a higher efficiency without impeding flows of vaporized substances.

Also, in the above-described embodiment, the wiping material (cloth, paper, fluorocarbon polymer sheets etc.) has been mounted as the material 16 on the sample holder tray 171. Alternatively, a small-sized sample such as a fragment of an explosive may be mounted on the sample holder tray 171.

Furthermore, the above-described substances may involve explosives, combustible dangerous substances, self-combusting dangerous substances, ignition dangerous substances, fireworks, matches, poisons, and the like, but the present invention is not limited thereto.

As previously described in detail, in accordance with the substance detection apparatus of the present invention, the substances can be detected in higher sensitivities even in such a case that the vapor pressure of the substances is low, and also, in the case that the amounts of the substances are very small.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. A method of detecting a substance adhered to a sample, comprising the steps of:
heating said sample adhered to said substance with a temperature at which said substance is readily vaporized to vapor said substance;
sucking air and feeding said sucked air in a direction different from a direction along which said substance is vaporized;
negatively ionizing said vapor sucked with said air; and
detecting said substance adhered to said sample by analyzing said negative ion.

2. A substance detection apparatus comprising:
a sample introduction unit that heats said sample adhered to said substance with a temperature at which said substance is readily vaporized to vapor said substance;
an ionizing unit that ionizes said vapor fed from said sample introduction unit;
a mass anaylzing unit that maintains an under decompression condition to analyze an ion ionized by said ionizing unit;
a control unit that controls said sample introduction unit, said ionizing unit and said analysis data processing unit; and
an analysis data processing unit that processes data analyzed by said first analysis data processing unit to display the processed data on a screen.

3. A substance detection apparatus as claimed in claim 2 wherein:
said sample introduction unit is comprised of:
a sample holder tray for mounting thereon the sample to which said substance has adhered;
a heating unit for heating said sample mounted on said sample holder tray so as to vapor said substance adhered to said sample; and
an air introduction tube for sucking air, for feeding said sucked air in a direction different from a direction along which said substance is vaporized, and for introducing said vapor to said ionizing unit.

4. A substance detection apparatus as claimed in claim 3 wherein:
said sample holder tray owns a handle which can be inserted and drawn with respect to said heating unit.

5. A substance detection apparatus as claimed in claim 4 wherein:
a switch used to transmit an acquisition timing signal of said data via said control unit to said analysis data processing unit; and
a switch depressing portion used to depress said switch against said handle are provided with said sample introduction unit.

6. A substance detection apparatus as claimed in claim 3 wherein:
a heat-purpose heater is provided with said air introduction tube, said sucked air is heated by said heat-purpose heater, and said heated air is fed in the direction different from the direction along which said substance is vaporized.

7. A substance detection apparatus as claimed in claim 4 wherein:
a heat-purpose heater is provided with said air introduction tube, said sucked air is heated by said heat-purpose heater, and said heated air is fed in the direction different from the direction along which said substance is vaporized.

8. A substance detection apparatus as claimed in claim 5 wherein:
a heat-purpose heater is provided with said air introduction tube, said sucked air is heated by said heat-purpose heater, and said heated air is fed in the direction different from the direction along which said substance is vaporized.

9. A substance detection apparatus as claimed in claim 3 wherein:
a filter for removing dust contained in air is provided with said air introduction tube.

10. A substance detection apparatus as claimed in claim 4 wherein:
a filter for removing dust contained in air is provided with said air introduction tube.

11. A substance detection apparatus as claimed in claim 5 wherein:
a filter for removing dust contained in air is provided with said air introduction tube.

12. A substance detection apparatus as claimed in claim 6 wherein:
a filter for removing dust contained in air is provided with said air introduction tube.

13. A substance detection apparatus as claimed in claim 7 wherein:
a filter for removing dust contained in air is provided with said air introduction tube.

14. A substance detection apparatus as claimed in claim 8 wherein:
a filter for removing dust contained in air is provided with said air introduction tube.
